(19) United States
(12) Patent Application Publication
(10) Pub. No.: US 2019/0256096 A1
(43) Pub. Date: Aug. 22, 2019

(54) Driver Assistance System

(71) Applicant: CPT Group GmbH, Hannover (DE)

(72) Inventors: Friedrich Graf, Sinzing (DE); Stefan Grubwinkler, Massing (DE)

(73) Assignee: CPT Group GmbH, Hannover (DE)

(21) Appl. No.: 16/333,419

(22) PCT Filed: Sep. 19, 2017
(86) PCT No.: PCT/EP2017/073665

§ 371 Date: Mar. 14, 2019

(30) Foreign Application Priority Data
Sep. 21, 2016 (DE) 10 2016 218 070.3

(51) Int. Cl. B60W 30/18; B60W 10/06; B60W 10/184; G08G 1/01

(52) U.S. Cl. CPC B60W 30/18072; B60W 10/06; B60W 10/184; B60W 30/18109; G08G 1/0125; B60W 2550/20; B60W 2400/00; B60W 2710/06; B60W 2710/18; B60W 2550/40; B60W 2030/1809

(57) ABSTRACT

Various embodiments include a driver assistance system for a vehicle comprising: a communication apparatus for communication with a backend system; a sensor arrangement for capturing vehicle data and surroundings data; and a controller for initiating and performing a deceleration of the vehicle optimized with relation to energy consumption, based at least in part on: data received by the communication apparatus from the backend system, vehicle data, and surroundings data. The deceleration is split into a coasting phase and a braking phase.

### CROSS-REFERENCE TO RELATED APPLICATIONS

This application is a U.S. National Stage Application of International Application No. PCT/EP2017/073665 filed Sep. 19, 2017, which designates the United States of America, and claims priority to DE Application No. 10 2016 218 070.3 filed Sep. 21, 2016, the contents of which are hereby incorporated by reference in their entirety.

### TECHNICAL FIELD

The present disclosure relates to vehicles. Various embodiments may include driver assistance systems, vehicles, methods, and/or computer-readable media for driver assistance systems that determine optimum braking patterns.

### BACKGROUND

Increased environmental awareness and higher demands on consumption, CO2 emissions, and other emissions have led in recent years to new driver assistance systems. To further reduce fuel consumption in vehicles, the focus is shifting to deceleration, since in this instance, in conventional vehicle designs, the kinetic energy of the vehicle is converted into heat by means of the brake system. Therefore, the kinetic energy of the vehicle is not used further and the brake system of the vehicle wears out. For this reason, designs are being developed in order to recover the kinetic energy of the vehicle during deceleration or to use the kinetic energy directly.

Deceleration in vehicles can be made up of a coasting phase and a braking phase. Coasting denotes a vehicle function in which the internal combustion engine is isolated from the drivetrain in order to allow the vehicle to roll. There is accordingly no driving by an engine. On a flat road, the vehicle decreases speed as a rule, since the air resistance, the friction of the tyres and the losses in the drivetrain are contrary to the kinetic energy of the vehicle. Besides that, the deceleration torque is reduced, since the internal combustion engine no longer has to be carried along owing to the open clutch. However, there is also the possibility of a vehicle gaining speed in the coasting phase, e.g. if the vehicle is on a sloping road. The fuel saving in the coasting phase results from reduced fuel injection.

### SUMMARY

The teachings of the present disclosure may provide systems and/or methods to lower the fuel consumption of a vehicle. For example, some embodiments include a driver assistance system (100) for a vehicle (400), having: a communication apparatus (140) for communication with a backend system (200); a sensor arrangement (180, 181) for capturing vehicle data and surroundings data; and a controller (110) for independently initiating and performing a deceleration of the vehicle that is as optimum as possible from an energy point of view, taking into consideration data that the communication apparatus (140) has received from the backend system (200) and the vehicle and surroundings data; wherein the deceleration is split into a coasting phase and a braking phase.

In some embodiments, the data interchange with the backend system (200) is effected wirelessly and in real time.

In some embodiments, the driver assistance system (100) is designed for analyzing the individual driving behavior of the driver and for creating a driver profile corresponding thereto.

In some embodiments, the controller (110) is designed for calculating the beginning of the deceleration phase and the transition between the coasting phase and the braking phase taking into consideration the individual driver behavior.

In some embodiments, the controller (110) is designed for calculating the beginning of the deceleration phase taking into consideration a driver's wish.

In some embodiments, the controller is designed for conditioning and presenting the data of the individual driver in regard to the mean value of all drivers.

As another example, some embodiments include a backend system (200) for a driver assistance system (100) as described above, having: a communication apparatus (240) for communication with the driver assistance system (100) of the vehicle (400); a computing unit (210) for processing the surroundings and vehicle data received by the communication apparatus (240) in order to generate the data to be sent to the driver assistance system; and a database (230) for storing the data obtained.

In some embodiments, the computing unit is designed for storing the surroundings and vehicle data of the individual users, in particular the deceleration data, in a database (230) of the backend system (200).

In some embodiments, the controller is designed for statistically evaluating the data obtained.

In some embodiments, the controller is designed for forming a mean value for all vehicles from which data are received.

As another example, some embodiments include a vehicle (400) having a driver assistance system (100) as described above.

As another example, some embodiments include a method for initiating and performing a deceleration of a vehicle, which has the following steps: sending (301) surroundings and vehicle data to a backend system; receiving (302) data from the backend system; processing (303) the received backend data; initiating a deceleration (304), based on the received data; initiating a coasting phase (305), based on the received data; and initiating a braking phase (306), based on the received data.

As another example, some embodiments include a program element that, when executed on a controller for a driver assistance system, instructs the driver assistance system to carry out the method as described above.

As another example, some embodiments include a computer-readable medium on which a program element as described above.

### BRIEF DESCRIPTION OF THE DRAWINGS

Further features, advantages, and possible uses of the teachings herein emerge from the following description of the exemplary embodiments and figures. The figures are schematic and are not to scale. Where the same reference signs in various figures are stated in the description below, they denote identical or similar elements.

FIG. 1 shows a schematic depiction of a driver assistance system for a vehicle for independently initiating a deceleration incorporating teachings of the present disclosure;

FIG. 2 shows a graph in which the deceleration phase is split into coasting phase and braking phase;

FIG. 3 shows a flowchart for a driver assistance system for a vehicle incorporating teachings of the present disclosure;

FIG. 4 shows a vehicle having a driver assistance system incorporating teachings of the present disclosure;

FIG. 5 shows a graph in which the coasting and braking behavior of individual users is plotted; and

FIG. 6 shows a schematic depiction of the backend system and the data records contained therein incorporating teachings of the present disclosure.

### DETAILED DESCRIPTION

Some embodiments of the teachings of the present disclosure include a driver assistance system for a vehicle, wherein the driver assistance system has a communication apparatus for communication with a backend system, a sensor arrangement for capturing vehicle and surroundings data and a controller, which is subsequently also referred to as a drivetrain controller. The controller is used for independently initiating and performing a deceleration of the vehicle that is as optimum as possible from an energy point of view, taking into consideration data that the communication apparatus receives from the backend system, wherein the deceleration is split into a coasting phase and a braking phase.

The length of the coasting phase can be dependent on the vehicle speed at the beginning of the deceleration. When the internal combustion engine is decoupled, the losses in the drivetrain are low. Thus, the length of the maximum possible coasting phase is very long. It can be over 500 m long, for example in the event of a deceleration process from 50 km/h to 0 km/h, depending on the driving resistances of the vehicle. From energy aspects, a coasting phase that is as long as possible is desirable. However, the driver would not accept the maximum length of the coasting phase in most cases. An accepted length of the coasting phase is dependent on the speed at the beginning of the coasting process, on the individual driving style of the driver, such as e.g. eco-awareness, accepted additional journey time, on the surrounding road users, such as e.g. traffic flow, distance from vehicle in front and behind, and on ambient conditions, such as e.g. visibility, traffic control, road signs.

The multiplicity of different influencing parameters makes the optimum beginning of the deceleration difficult to determine. Too early a start for the coasting phase would result in the vehicle becoming distinctly slower in comparison with other road users and therefore obstructing the flowing traffic. Also, the driver would sometimes not accept this behavior of the driver assistance system and would manually override the coasting phase, which is contrary to efficient and energy-saving use of the driver assistance system. The driver assistance system is meant to be focused on a maximum period of use by the user. This results in the driver assistance system calculating and implementing not the theoretically possible maximum length of the deceleration in every case, but rather the length of deceleration phase that the user will probably accept, so that the user experience turns out to be positive.

The stipulation by the driver assistance system can be matched to the current driving situation on the basis of ambient conditions, such as e.g. traffic, vehicles in front, visibility. A challenge when stipulating deceleration strategy is the ideal determination of the beginning of the coasting phase and of the transition to the braking phase.

Deceleration or stopping processes are effected when approaching a speed restriction, a curve, a junction with right of way or a slower vehicle. The driver assistance system can ascertain the required deceleration and coasting data for the drivetrain controller by evaluating the vehicle component states, such as for example of the internal combustion engine, of the generator, of the optional electric motor, of a converter, of a battery, of a gearbox, of a clutch, of the gas pedal, and of the brake pedal. In addition, vehicle sensor data, such as radar and camera data, can be taken into consideration by the drivetrain controller. The vehicle data ascertained by the drivetrain controller are handed over in geo-referenced fashion to the transmission and reception unit, which transfers the vehicle data to the backend system. The geo-referencing is effected by the positioning module of the vehicle and takes into consideration not only the position of the vehicle but also the map data, including the traffic nodes stored therein.

Traffic nodes within the context of the disclosure are all areas occurring in road traffic in which adjustment of the speed of the vehicle is appropriate. This includes road junctions, with and without signals, the start of villages, speed reductions, brought about by road signs or by road conditions, such as curves, wetness, woodland, slipperiness, pedestrian crossings, danger areas, vehicles in front and behind, sloping roads and navigation destinations too.

The vehicle is located by means of a locating unit. This locating unit can be effected on satellite locating systems such as GPS. Furthermore, it should be pointed out that, within the context of the present invention, GPS is representative of all global navigation satellite systems (GNSSs), such as e.g. GPS, Galileo, GLONASS (Russia), Compass (China), IRNSS (India). At this juncture, it should be pointed out that the position determination of the vehicle can also be effected by means of cell positioning. This is possible in particular when using GSM, UMTS and LTE networks.

A hop denotes the one-off fresh transmission of the message as a broadcast and thus the forwarding to other objects outside the range of the original sender.

The term “digital maps” or “digital map data” is also intended to be understood to mean maps for advanced driver assistance systems (ADASs), without navigation taking place.

The determination of the optimum and driver-accepted length of the deceleration phase is dealt with by a networked approach in which the individual vehicles are connected to a backend system.

On the basis of this comprehensive information, an energy-optimum deceleration trajectory may be anticipatively stipulated. The driver is provided with an indication of how he can follow the deceleration trajectory, or the driver assistance system independently undertakes the deceleration for the next driving situation.

In most cases, the braking phase follows on from the coasting phase. For particular operating points and drivetrain configurations, the reverse order can also be more energy-efficient in certain situations. E.g. during descents or in the event of decelerations from high speeds, where high driving resistances are contrary to coasting. The beginning of the deceleration phase is frequently determined by a predictive operating strategy. This is determined on the basis of map attributes such as speed limits and road signs and also the vehicle surroundings captured by the vehicle sensors.

The energy consumption of vehicles can be lowered by virtue of the coasting phases being extended. To achieve this, a deceleration profile is stipulated. The driver assistance system determines the optimum time, in terms of energy, for beginning the deceleration of the vehicle based on backend data.

On the basis of the data sent from the vehicle to the backend system, the relevant data for the current vehicle location or the planned vehicle route can be transmitted from the backend system to the transmission and reception unit of the vehicle and subsequently to the drivetrain controller. From the available vehicle data, and from the data from the backend system, the drivetrain controller calculates the optimum beginning of deceleration, which is split into a coasting phase and a braking phase. The driver assistance system is further able to initiate the deceleration independently or to provide the driver of the vehicle with advice of the optimum behavior.

By collecting information pertaining to deceleration, in particular pertaining to coasting and braking, in a backend system, the operating strategy can be improved, and adjusted over the life of the system, such that the start and hence the length of the deceleration is matched to the current situation on the basis of location taking into consideration the current surroundings information, such as for example traffic, time of day and visibility. As a result, the length of the deceleration for the current traffic node can be determined on the basis of the evaluation of the past decelerations at this traffic node. The backend system can associate applicable data records with particular traffic nodes. In addition, the backend system can evaluate and analyze the stored data records according to various aspects.

The data from past decelerations, in particular in the coasting and braking phases, of different vehicles can be collected in the backend system. The data stored in the backend system can determine the optimum beginning, in terms of energy, for the deceleration by means of data processing. When the vehicle data are collected, vehicle-internal signal variables, such as e.g. pedal positions, internal vehicle states, modes of operation and vehicle speed, are evaluated and hence the length and time of the deceleration phase are determined. Besides that, the duration and length of the coasting phase are also recorded. Since the parameters of the coasting phase are dependent on the speed at the beginning of the coasting process, additionally the relative proportion of the decrease in speed in the coasting phase in the total reduction in speed during the deceleration process is determined. The relative proportion of the decrease is independent of the starting speed of the deceleration process.

In some embodiments, the short-term and long-term average values are weighted for the traffic nodes on the basis of the number and up-to-dateness of the data in the backend system. Since the backend system can store the distribution of the coasting and braking variables for different traffic flows, this influence can likewise be taken into consideration with a weighting factor on the basis of the traffic situation to be expected at the traffic node. As a result, the start of the coasting and braking phase is determined according to the situation to be expected. Instead of the average values of the collected data, a multiple of the standard deviation can also be used in order to allow the deceleration to begin consciously earlier in the situation to be expected than for past journeys. This means that matching to the existing traffic flow is possible in more or less defined fashion.

The braking phase can include both the operation of the mechanical brake device on the vehicle and the regenerative braking by means of an electric motor. The electric motor can be a drive suitable for propelling the vehicle or a generator in the belt of the internal combustion engine or a starter for the internal combustion engine.

The driver assistance system described can be used in a multiplicity of vehicle designs. Besides conventional vehicles having an internal combustion engine, in particular hybrid vehicles are of interest on account of the possibility of recuperation at high powers by the electric motor. In this case, it is irrelevant whether they are micro, mild or full hybrid vehicles. The driver assistance system is also able to be used for pure electric vehicles and for vehicles having alternative energy sources, such as for example fuel cell vehicles and natural gas vehicles. The description motor vehicle is not limited solely to an automobile, but also includes trucks, buses, tractors, tanks, construction machines, rail vehicles, ships, aircraft, such as helicopters or airplanes, bicycles and motorcycles too.

In some embodiments, the data interchange between the driver assistance system and the backend system is effected wirelessly and substantially in real time. This is intended to be understood to mean that the data interchange is effected during the journey and can also be updated in the event of a differing route, and also includes current influences too.

In some embodiments, a communication unit communicates with the backend system via an antenna using a wireless communication connection, such as e.g. Bluetooth, WLAN (e.g. WLAN 802.11a/b/g/n or WLAN 802.11p), ZigBee or WiMax or else also cellular radio systems such as GPRS, UMTS or LTE. It is also possible to use other transmission protocols. The specified protocols provide standardization which has already taken place. Therefore, the data can be interchanged during the journey and the information is transferred from and received by the vehicle according to the situation. This allows short-term adjustment of the deceleration strategy and it is possible to react to current reports, e.g. congestion reports, reports of roadworks or accident reports.

Even if there is a constant interchange between the backend system and the vehicle, data can be stored locally on the vehicle in order to reduce the data transfer or to ensure the functionality of the driver assistance system even without wireless communication. In particular in the case of repeating journey routes, such as the daily route to work or shopping, the data transfer is reduced without restricting the system.

C2X communication comprises C2C communication (vehicle-to-vehicle communication) and communication between a vehicle and a further device that is not a vehicle, such as for example an infrastructure device (traffic lights, etc.).

In some embodiments, the driver assistance system analyzes the individual driving behavior of the driver and creates a driver profile. A driver assistance system intervening in the driving behavior of the vehicle should have the ability to take into consideration the individual habits of the driver in order to ensure a positive customer experience. In some embodiments, the systems analyzes and evaluates the driving behavior of the individual drivers. The driver-individual rating of the coasting behavior allows the efficiency of the deceleration process to be rated for each driver. This means that potentials for further improvement of the coasting behavior can be suggested to the driver. The data of the individual drivers can be anonymized in the backend system or stored on a person-/vehicle-related basis. If the data are stored in the backend system in anonymized fashion, the corresponding person-related data records can be deposited in the data memory of the vehicle.

In some embodiments, the optimum beginning of the deceleration phase and the transition between the coasting phase and the braking phase are calculated taking into consideration the individual driver behavior. On the basis of the driver-individual analysis, it is possible to match the operating strategy for determining the optimum beginning, in terms of energy, of the deceleration to the individual driving behavior. This also applies to driving sections that follow deceleration, such as cornering. It is therefore possible for sporty or reserved driving by the driver to be taken into account by virtue of the deceleration turning out to be heavier or lighter in comparison with an average driver. As a result of the driver-individual behavior and the deceleration behavior of the other road users at a particular traffic node being taken into consideration, the likelihood of the suggestion by the driver assistance system being accepted by the driver increases. This prevents the driver from deactivating the driver assistance system or overriding the system stipulations. This ultimately leads to greater user satisfaction and to a higher CO2 saving by the driver assistance system.

The duration of the deceleration and of the coasting phase is extended or shortened in comparison with the calculated comparison value from the backend system on the basis of the individual driver behavior. There are multiple options in this regard: The difference between the driver-individual behavior and that of drivers as a whole is taken into consideration on the basis of the expected situation using a dynamic weighting factor. This allows the driver behavior to be weighted at a higher level in traffic-calmed situations than in situations with a high traffic load, in which the individual driver behavior can have a lesser influence.

The driver has the option of selecting different modes for the driver assistance system. It is thus possible for the difference in the driver-individual behavior to be weighted at different levels. E.g. in an eco-mode not just the average difference in the individual length of the deceleration is taken into consideration but also a multiple of the standard deviation of the individual driving behavior. This also includes the speed at which the driver takes particular curves. On the basis of that, the vehicle is brought to an appropriate speed before the curve. The driver can alternatively use different driving modes to adjust the preferred transverse accelerations. The level of the weighting of the driver-individual difference can also be provided on the basis of the last decelerations for the current journey. If the driver—for example when driving under time pressure—begins to decelerate very late in comparison with his previous behavior, this can be detected on the basis of the last deceleration processes and taken into consideration as appropriate for the subsequent decelerations on this journey. A combination of the cited previous options is also conceivable. The previous options involve the data about the driver-individual coasting and braking behavior being weighted such that the beginning of the deceleration corresponds to the expectation of the driver.

In some embodiments, the beginning of the deceleration phase is continuously adjusted in the direction of a lower consumption on the basis of the driver's wish, which means that the consumption can be continuously lowered. The data of the driver-individual deceleration behavior can be used so that the vehicle decelerates in increasingly more energy-efficient fashion. Knowledge of the driver-individual deceleration behavior allows deceleration to be gradually extended, so that the driver slowly adjusts to an energy-efficient way of driving. As an alternative to a probabilistic approach, it is also possible for the individual influences to be weighted on the basis of a machine learning method.

In some embodiments, the data of the individual driver are conditioned and presented in regard to the mean value of all drivers. Conditioning of the data and the presentation of the data in graphical form is used to illustrate the driving behavior in comparison with the public at large under similar constraints. The presentation can be effected inside the vehicle in this case, but can also be available on the backend system, in order to be able to see it later too. To increase the motivation of the individual driver, it is also possible for elements typical of games to be used, such as e.g. ranking lists for driver groups and rewards for intensive use of the driver assistance system. This information can also be used for CO2 rating for a vehicle fleet, e.g. of a company.

In some embodiments, there is a backend system for a driver assistance system. The backend system has a computing unit, for processing the data, a communication apparatus, for communication with the vehicles, and a database, for storing the collected deceleration and coasting data. Besides that, map data are stored as collected data in geo-referenced fashion. Additionally, a computing unit may process and evaluate the collected data. The database of the backend system stores data pertaining to the traffic nodes in geo-referenced fashion. These data may be passed to the vehicles by means of the communication apparatus. The computing unit is needed in order to condition the required data from the database according to the situation and to make them available to the vehicles. In addition, the computing unit may perform statistical evaluations of the stored data.

The end of the deceleration is determined for example by the position of the traffic node or by other vehicles detected by means of the ambient sensors of the vehicle. Based on the end point and the available data, both from the backend system and from the vehicle data and the individual driver, the optimum beginning of the deceleration, the beginning of the coasting phase and the beginning of the braking phase can be calculated and if need be implemented by the driver assistance system independently.

In some embodiments, the backend system is used to store the surroundings and vehicle data of the individual users, in particular the deceleration data, in the database of the backend system. The data received from the vehicles may be geo-referenced and classified using the vehicle sensor data. In addition, data such as date, day of the week, holidays, time of day and weather data may be included in the database too. The backend system grows during the operation of the driver assistance system and increases the number of stored data records, and hence the system is constantly being improved and a larger database is produced in order to constantly improve the predictions for the optimum beginning, in terms of energy, of the deceleration.

Since the individual driver behavior is rated in comparison with the public at large, it is sufficient if the data from all drivers are stored in anonymized fashion in the backend system and the coasting and braking data of each driver are deposited locally in the vehicle. These data may be used by the drivetrain controller for taking into consideration the driver-individual deceleration behavior. However, there can also be provision for storage of all collected data in the backend system.

In some embodiments, a statistical evaluation of the data obtained is effected in the backend system. The computing unit of the backend system can perform statistical evaluations of the stored data. Multiple configurations are conceivable for this. As such, a distribution over a long-term period and over a short-term period, e.g. the last hour, can be calculated. The classification of the calculated distributions for each traffic node is effected for example on the basis of the relevant influencing factors, such as e.g. volume of traffic, time of day and visibility. The driver-individual coasting and braking behavior can be analyzed in regard to a comparison value. Since the distribution of the coasting data is determined for each traffic node according to the situation, it is possible to ascertain how the data of the individual driver differ in comparison with the public at large. As such, it is possible to establish for example whether a driver coasts and/or decelerates earlier or later or more or less in comparison with the public at large. The attributes of the traffic nodes on the digital map can be extended with the characteristic data of the ascertained distributions of the deceleration and coasting data, such as for example average value, variance and standard deviation.

In the case of vehicles allowing recuperation of the vehicle energy, the possible recuperation power can be taken into consideration in the calculation of the optimum beginning of the deceleration. The optimum length, in terms of energy, of the recuperation phase is obtained from the available recuperation power of the electric machine in the vehicle. Hence, the beginning of the coasting phase can ultimately be determined variably if the braking phase is preceded by a coasting phase. The map attributes additionally stored in the backend for coasting and deceleration phases are used to determine the beginning of the deceleration. A probabilistic approach is suitable for this. For the relevant traffic node, the data stored in the backend system are used to determine the average length of the deceleration and hence the surroundings information is taken into consideration to determine the beginning of the deceleration.

In some embodiments, the backend system is used to form a mean value for all vehicles from which data are received. It is also possible for all drivers at the applicable position of the traffic node to be included in the calculations in the backend system too, or else just some of the drivers who have a similar driving behavior to the driver. Hence, the averaging is dynamic and is matched to the constraints as required. That is to say that the driver type of a driver can change over time and the data to be compared and the corresponding driver types are selected according to the situation.

Some embodiments include a vehicle having a driver assistance system for determining the beginning of an optimum deceleration in terms of energy is described. The vehicle having this driver assistance system can also initiate and perform the optimum deceleration in terms of energy independently.

Some embodiments include a method for a driver assistance system for a vehicle, which has the following steps:
sending surroundings and vehicle data to the backend system;
receiving data from the backend system;
processing the received backend data;
initiating the deceleration, based on the received data;
initiating the coasting phase, based on the received data;
initiating the braking phase, based on the received data.

The methods may be used for determining and independently performing an optimum deceleration of the vehicle in terms of energy. Some embodiments include a program element that, when executed by a controller, instructs the controller to carry out the method described above. Some embodiments include a computer-readable medium on which a computer program is stored that, when executed by a controller, instructs the controller to carry out the method described above.

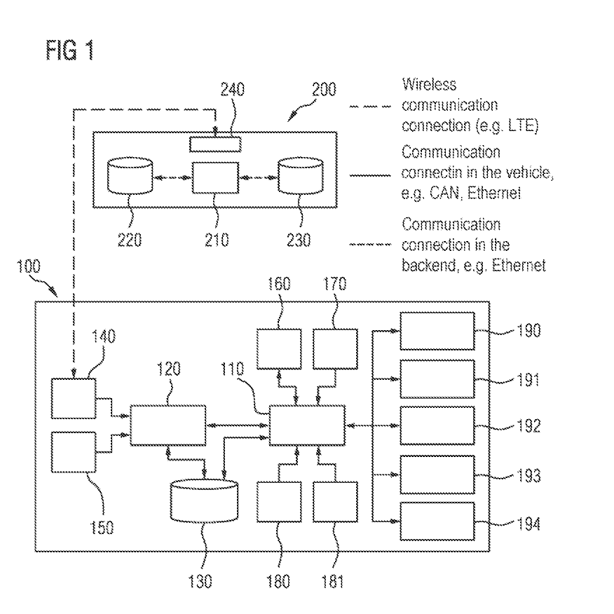

FIG. 1 shows a driver assistance system 100 for a vehicle 400 for determining the optimum beginning, in terms of energy, of a deceleration that matches the ambient conditions and is accepted by the user, taking into consideration data from a backend system 200. The system has the following components: a communication device 140 for communication with the backend system 200 and a positioning device 150 for determining the current location of the vehicle. In addition, the vehicle has a navigation module 120 having appropriate map material that also stores the road signs, junctions and speed limits.

The vehicle database 130 is used to locally store data for the determination, among other things also the individual driver type of the vehicle user. The vehicle sensors 180, 181, such as for example camera, radar or thermometer, are, like the gas pedal 160 and the brake pedal 170, connected to the drivetrain controller 110. The drivetrain controller 110 is used to effect control of the optimum beginning of the deceleration in terms of energy. The drivetrain controller 110 further takes the calculated data as a basis for controlling vehicle components, such as internal combustion engine 190, gearbox 191, battery 192 and if need be an electric motor 193 and the applicable power electronics 194. Alternatively, it is possible to display the applicable information to the driver on the dashboard by means of the controller, the driver then carrying out the further steps.

The backend system 200 is the further component of the driver assistance system 100. The backend system 200 includes a communication device 240 for communication with the vehicles 400 and map material 220 for geo-referencing, a database 230 and a computing unit 210.

The driver assistance system 100 uses the drivetrain controller 110 to collect data from the various vehicle sensors 180, 181, the gas pedal 160 and the brake pedal 170. The data obtained are transmitted wirelessly, together with the vehicle position from the positioning device 150 and the relevant map information 120, to the communication device 240 of the backend system 200 by means of the communication device 140 of the vehicle.

The backend system 200 processes the received data in the computing unit 210 and compares them with stored data in the database 230. On the basis of the map information 220 of the backend system 200 and the vehicle data, the relevant data for determining the optimum beginning of the deceleration in terms of energy are sent to the vehicle 400. The data sent by the vehicle 400 are stored in the database 230 of the backend system 200 and are used for continually improving the driver assistance system 100.

The communication device 140 of the vehicle receives the sent data of the backend system 200 and forwards them to the drivetrain controller 110. The drivetrain controller is used to calculate the optimum beginning of the deceleration in terms of energy taking into consideration the data from the backend system 200, the stored driver type in the vehicle database 130 and its own collected data. The deceleration is split into a coasting phase and a braking phase. After deceleration is complete, the data collected during the deceleration, in particular the characteristic and duration of the individual phases and the intervention of the driver, are transmitted to the backend system 200, and the database of the backend system 200 can store the further data record.

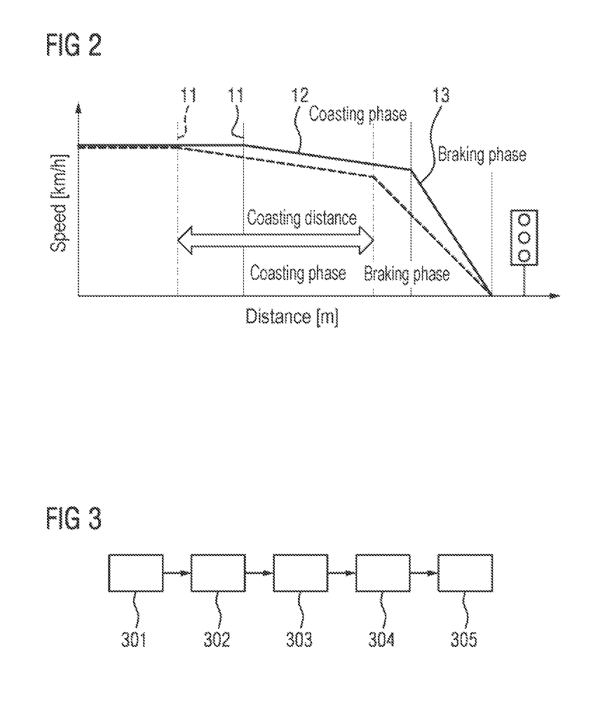

FIG. 2 depicts a graph in which the deceleration phase is effected in two different scenarios. The abscissa depicts the distance in meters and the ordinate plots the speed of the vehicle. The end point, at which the speed of the vehicle is zero, is identical in both scenarios. Based on the endpoint, the invention determines the optimum beginning of the deceleration in terms of energy. The optimum deceleration in terms of energy can be dependent on different parameters and is calculated as required, and therefore both scenarios depict an optimum beginning of a deceleration in terms of energy, but with different input parameters.

The deceleration is split into a coasting phase and a braking phase in each case. The coasting phase is characterized by decoupling of the engine from the drivetrain, and therefore losses are reduced and the vehicle coasts to a standstill. The braking phase is characterized in that the decrease in speed is in the foreground, this being able to be effected firstly by operating the brake devices on the vehicle, i.e. operating the brake, by recuperating the vehicle energy by means of an electric motor or by coupling the engine and utilizing the engine brake.

In scenario 1 (solid line), the beginning of the deceleration and therefore the beginning 11 of the coasting phase 12 is placed such that it starts relatively late. The coasting phase is followed by the braking phase 13, which is relatively short and intensive in this example, in order to reduce the speed quickly and to obtain a coasting phase 12 that is as long as possible. Scenario 1 reflects the average behavior of a multiplicity of vehicles.

In scenario 2 (dashed line), the deceleration is determined in an optimum manner in terms of energy, but the deceleration begins somewhat earlier in comparison with scenario 1 and the braking phase is extended by contrast with scenario 1. The extension of the braking phase can be appropriate if the vehicle having the driver assistance system according to the present invention has a system for recuperation and the energy can therefore be recovered.

FIG. 3 shows a flowchart 300 for a method for a driver assistance system for determining the optimum beginning of a deceleration phase in terms of energy based on backend data. In step 301, the vehicle sends surroundings and vehicle data to the backend system by means of the communication device. The backend system evaluates these data and then transmits the applicable data to the vehicle in step 302, said data being used for determining the optimum beginning of the deceleration in terms of energy. The drivetrain controller takes the collected vehicle data and the received data from the backend system as a basis for calculating the optimum beginning of the deceleration in terms of energy in step 303 and initiates the deceleration in step 304. In step 305, the coasting phase is initiated, followed by the braking phase in step 306.

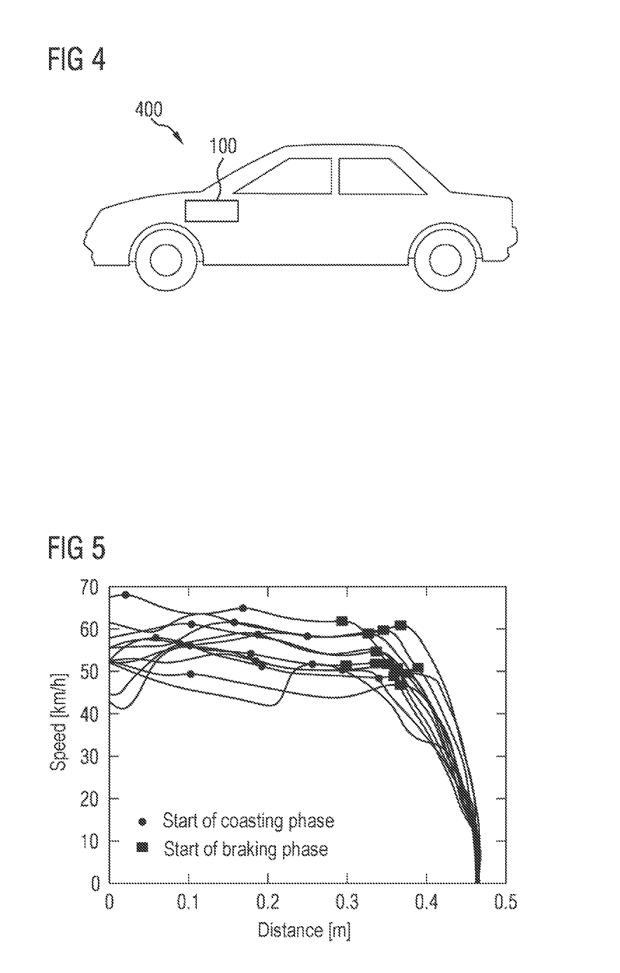

FIG. 4 shows a vehicle 400 having the driver assistance system 100 for determining the optimum beginning of the deceleration phase in terms of energy. The communication device 140 is mounted in or on the vehicle in order to be able to communicate with the backend system.

The graph from FIG. 5 depicts the deceleration behavior of individual users of the driver assistance system. The abscissa plots the distance in km and the ordinate plots the speed of the vehicles in km/h. Each individual line depicts a different user. The coasting phase can be seen in the left-hand part of the graph, the coasting phase being characterized in that the speed of the vehicle is reduced only to a small degree. The right-hand part of the graph shows the braking phase of the individual vehicles. In the braking phase, the speed reduction is effected relatively quickly in comparison with the coasting phase.

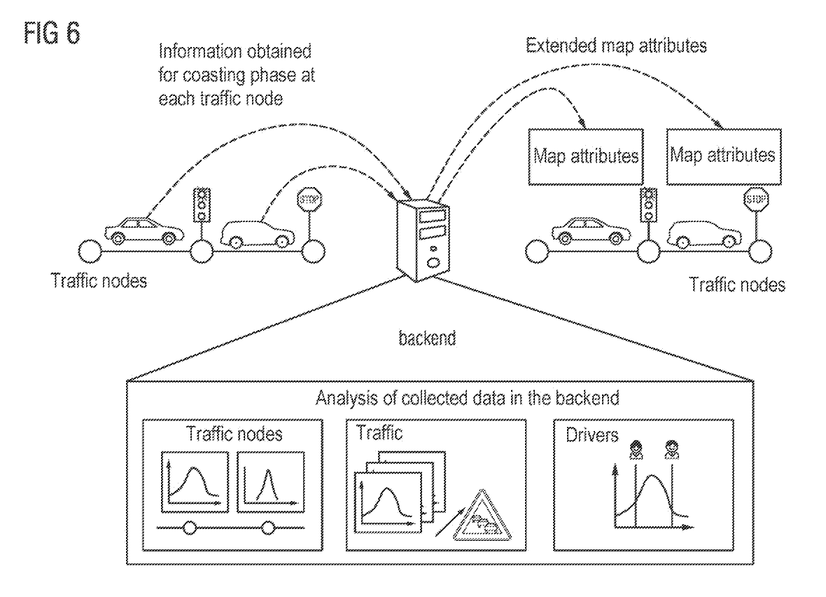

FIG. 6 shows the backend system that obtains the data of the individual traffic nodes through the vehicles. The data obtained may be classified according to various criteria, for example according to the individual traffic nodes, the traffic situation or the driver type. The backend system can adjust the individual map attributes in the database according to the data obtained from the vehicles. This constantly improves the driver assistance system over the course of time.

What is claimed is:

1. A driver assistance system for a vehicle, the system comprising:
a communication apparatus for communication with a backend system;
a sensor arrangement for capturing vehicle data and surroundings data; and
a controller for initiating and performing a deceleration of the vehicle optimized with relation to energy consumption, based at least in part on: data received by the communication apparatus from the backend system, vehicle data, and surroundings data;
wherein the deceleration is split into a coasting phase and a braking phase.

2. The driver assistance system as claimed in claim 1, wherein the communication apparatus interchanges data with the backend system wirelessly and in real time.

3. The driver assistance system as claimed in claim 1, wherein the controller analyzes the individual driving behavior of the driver and for creates a driver profile corresponding thereto.

4. The driver assistance system as claimed in claim 1, wherein the controller calculates the beginning of the deceleration phase and a transition between the coasting phase and the braking phase based at least in part on individual driver behavior.

5. The driver assistance system as claimed in claim 1, wherein the controller calculates a beginning of the deceleration phase based at least in part on a driver's input.

6. The driver assistance system as claimed in claim 1, wherein the controller conditions and presents data associated with an individual driver in relation to a mean value of all drivers.

7. A backend system for a driver assistance system, the backend system comprising:
a communication apparatus for communication with a driver assistance system of a motor vehicle;
a computing unit For processing surroundings and vehicle data received by the communication apparatus from the driver assistance system to generate data to be sent to the driver assistance system;
a database for storing the data obtained.

8. The backend system as claimed in claim 7, wherein the database stores surroundings and vehicle data of individual users.

9. The backend system as claimed in claim 7, wherein the computing unit evaluates
the data obtained.

10. The backend system as claimed in claim 7, wherein the computing unit forms a mean value for all vehicles from which data are received.

11. A vehicle comprising:
a wheel;
a braking system;
a communication apparatus for communication with a backend system;
a sensor arrangement for capturing vehicle data and surroundings data; and
a controller for initiating and performing a deceleration of the vehicle optimized with relation to energy consumption, based at least in part on: data received by the communication apparatus from the backend system, vehicle data, and surroundings data;
wherein the deceleration is split into a coasting phase and a braking phase wherein the braking system applies force against rotation of the wheel.

12. A method for initiating and performing a deceleration of a vehicle, the method comprising:
sending surroundings and vehicle data from the vehicle to a backend system;
receiving data from the backend system;
processing the received backend data;
initiating a deceleration of the vehicle, based on the received data;
initiating a coasting phase, based on the received data; and
initiating a braking phase, based on the received data.

13. (canceled)

14. A non-transitory computer-readable medium storing instructions, the instructions, when loaded and executed by a processor, configure the processor to:
send surroundings and vehicle data from a vehicle to a backend system;
receive data from the backend system;
process the received backend data;
initiate a deceleration of the vehicle based on the received data;
initiate a coasting phase based on the received data; and
initiate a braking phase based on the received data.
